(19) United States
(12) Patent Application Publication
(10) Pub. No.: US 2014/0037790 A1
(43) Pub. Date: Feb. 6, 2014

(54) STEAMED BUN QUALITY IMPROVING AGENT AND USE THEREOF

(71) Applicants: Qinglong Xu, Kakamigahara-shi (JP); Kimihiko Sato, Kakamigahara-shi (JP); Shotaro Yamaguchi, Kakamigahara-shi (JP)

(72) Inventors: Qinglong Xu, Kakamigahara-shi (JP); Kimihiko Sato, Kakamigahara-shi (JP); Shotaro Yamaguchi, Kakamigahara-shi (JP)

(73) Assignee: AMANO ENZYME INC., Nagoya-shi (JP)

(21) Appl. No.: 14/001,591

(22) PCT Filed: Feb. 20, 2012
(86) PCT No.: PCT/JP2012/053946

§ 371 Date: Oct. 15, 2013

(30) Foreign Application Priority Data
Feb. 28, 2011 (JP) 2011-042866

(51) Int. Cl. A21D 8/04

(52) U.S. Cl. CPC A21D 8/042
USPC 426/20; 426/64; 426/63; 435/205; 435/198; 435/227

(57) ABSTRACT

The present invention is intended to provide a quality improving agent useful for improving the quality of steamed buns, and a quality improving agent containing glucoamylase. The quality improving agent preferably has low protease activity.

### TECHNICAL FIELD

The present invention relates to a steamed bun quality improving agent, and the use thereof. The quality improving agent of the present invention is particularly useful for the maintenance of softness (Anti-staling) and improvement of color tone of steamed buns. The present application claims priority based on Japanese Patent Application No. 2011-042866 filed on Feb. 28, 2011, and the contents of the patent application is hereby incorporated by reference herein in its entirety.

### BACKGROUND ART

Steamed buns are a kind of breads produced by steaming a dough composed mainly of flour in a steaming atmosphere at generally 100° C. or lower using water vapor as a heat medium. In the same manner as other breads, steamed buns deteriorate in quality (especially texture) with time due to, for example, retrogradation of starch. Even when provided in the form of a frozen or chilled food for long-term storage, commonly the dough is dried by reheating (for example, by microwave oven), the appearance is wrinkled, and thus the commercial value markedly deteriorates. Maintenance of the characteristic softness of steamed buns for a long period of time is very important for increasing the commercial value of the steamed buns.

For the purpose of maintaining the quality of steamed buns, emulsifying agents having dough improving effect are used (for example see Patent Documents 1 and 2). The use of an emulsifying agent achieves certain effect, but the characteristic taste and odor of the emulsifying agent impairs the original good taste of steamed bun.

### PRIOR ART DOCUMENT

### Patent Document

Patent Document 1: Japanese Unexamined Patent Application Publication No. 8-205831
Patent Document 2: Japanese Unexamined Patent Application Publication No. 8-205758

### SUMMARY OF THE INVENTION

### Problems to be Solved by the Invention

The present invention is intended to provide a quality improving agent useful for improving the quality of steamed buns, and the uses thereof (for example, a method for producing steamed buns having improved quality).

### Means for Solving the Problem

In order to solve the above-described problems, the inventors carried out investigations. Especially for the purpose of improving quality without impairing the original taste of steamed buns, the inventors focused attention on enzymes, and carried out investigations. As a result of this, they have found that glucoamylase has quality improving effect on steamed buns. More specifically, they have found that the above-described problems can be solved by producing steamed buns using the steamed bun dough containing glucoamylase. It has been also proved that protease activity influences stickiness of the dough and workability during dough preparation. It has been also proved that lipase is effective for the improvement of the color of steamed buns, and the combined use of glucoamylase and lipase achieves higher quality improving effect than the use of glucoamylase alone. On the other hand, it has been found that protein glutaminase has quality improving effect on steamed buns, and the combined use of glucoamylase and protein glutaminase increases the quality improving effect. It has been also proved that the highest effect is achieved by the combination of three enzymes, glucoamylase, lipase, and glucoamylase.

The present invention has been accomplished based on the above-described results, and the details are described below.

[1] A steamed bun quality improving agent including glucoamylase.

[2] The quality improving agent according to [1], which has low protease activity.

[3] The quality improving agent according to [2], wherein the ratio of the protease activity to the starch-saccharifying power (protease activity/starch-saccharifying power) is 0.01 or less.

[4] The quality improving agent according to any one of [1] to [3], which further contains lipase.

[5] The quality improving agent according to any one of [1] to [4], which further contains protein-glutaminase.

[6] A steamed bun quality improving agent containing lipase.

[7] A steamed bun quality improving agent containing protein-glutaminase.

[8] A method for producing steamed buns, including a step of steaming a dough containing the quality improving agent according to any one of [1] to [7].

### DESCRIPTION OF EMBODIMENTS

### Terms

In the present description, the terms “steamed bun quality improving agent” means the enzyme preparation used in the production of steamed buns for improving steamed bun quality. Examples of the aspects of “quality” herein include softness, elasticity, crispness, color (whitening), long shelf life (for example, maintenance of softness and elasticity), and texture in the mouth. The quality improving agent of the present invention improves at least one aspect of the quality. In typical cases, the quality improving agent of the present invention maintains elasticity of steamed buns, while further softening them. In other words, this effect weakens the mechanical resistance of steamed buns against the deformation caused by applied force, and at the same time removes the applied force thereby restoring the deformed steamed buns.

In the present invention, the term “steamed buns” should be interpreted broadly, and includes Chinese buns such as those with pork or sweet bean, Mantou mainly eaten in China, and confectionery such as steamed buns with a bean-paste filling and steamed sponge cake. Examples of the ingredients of steamed buns include wheat, rice, glutinous rice, starch, and yam.

### 1. Steamed Bun Quality Improving Agent

A first aspect of the present invention relates to a steamed bun quality improving agent. The use of the quality improving agent of the present invention achieves, for example, maintenance of softness of steamed buns and elasticity without sticking in the mouth, even when stored for a long period in the form of a frozen or chilled food.

In one embodiment, the quality improving agent of the present invention contains glucoamylase. The glucoamylase is not particularly limited, as long as it achieves the effect found by the inventors (more specifically, maintenance of softness of steamed buns, and maintenance of elasticity without sticking in the mouth). The glucoamylase may be a commercially available enzyme preparation. Examples of the enzyme preparation include Glucoamylase “AMANO” 2, GLUC GIN, SOFTMAX S, GLUCZYME AF6 (manufactured by Amano Enzyme Inc.), NOVAMYL (manufactured by Novamyl), NOVAMYL (registered trademark) Steam (manufactured by Novozymes Japan), GRINDAMYL (manufactured by Danisco Japan).

As shown by the below-described examples, the protease activity in the quality improving agent is preferably low, thereby preventing dough stickiness. Specifically, the ratio of protease activity to the starch-saccharifying power (protease activity/starch-saccharifying power) is preferably 0.01 or less. More specifically, the activity ratio is preferably from 0.001 to 0.01. An example of the enzyme preparation which satisfies these conditions include the above-described SOFTMAX S. The starch-saccharifying power and protease activity are in principle calculated by the method shown in the below-described test example.

The degree of purification of the glucoamylase used in the present invention is not particularly limited (however, the degree of purification is preferably higher for lowering protease activity). For example, a plant extract, an animal extract, a microbial culture extract, or a partially purified product of any of them may be used as a component of the quality improving agent of the present invention, as long as it achieves the effect intended by the present invention.

The glucoamylase content is not particularly limited, and may be, for example, from 10% to 100%.

One embodiment of the present invention uses glucoamylase and lipase in combination. More specifically, a quality improving agent containing glucoamylase and lipase is provided. The combined use of glucoamylase and lipase can improve, for example, softness maintaining effect, and also exert whitening effect.

The lipase used in the present description is not particularly limited as long as it exerts the above-described effect found by the inventors. The lipase may be a commercially available enzyme preparation. Examples of the enzyme preparation include LIPASE A “Amano” 6, Lipase AH “AMANO” SD, LIPASE AY “AMANO” 30, LIPASE PS “AMANO” SD, LIPASE DF “AMANO” 15, Lipase M “AMANO”, LIPASE G “AMANO” 50, LIPASE R “AMANO” (manufactured by Amano Enzyme Inc.), LILIPASE A-10D (manufactured by Nagase ChemteX Corporation), GRINDAMYL EXEL639 (manufactured by Danisco Japan), DIET LENZ LIPASE CR, VARIDASE lipase MJ, BAKEZYME L80.000B, PICANTASE A, PICANTASE AN, PICANTASE R800, PICANTASE C3X, PICANTASE K, PICANTASE KL, PANAMORE GOLDEN, PANAMORE SPRING (manufactured by DSM Japan), LIPOPAN 50BG, LIPOPAN FBG (manufactured by Novozymes Japan) and ENCHIRON AKG (manufactured by Racto Kasei Industrial Co., Ltd.). The lipase is preferably LIPOPAN 50BG, LIPOPAN FBG, LIPASE M “AMANO”, or LIPASE DF “AMANO” 15, and most preferably LIPASE DF “AMANO” 15.

The degree of purification of the lipase used in the present invention is not particularly limited. For example, a plant extract, an animal extract, a microbial culture extract, or a partially purified product of any of them may be used as a component of the quality improving agent of the present invention, as long as it achieves the effect intended by the present invention.

The lipase content is, for example, from 2.5% to 50%. In principal, the lipase activity is calculated by the method shown in the below-described test example.

In one embodiment of the present invention, glucoamylase and protein glutaminase are used in combination. More specifically, a quality improving agent containing glucoamylase and protein-glutaminase is provided. The combined use of glucoamylase and protein-glutaminase can improve, for example, the softness and elasticity maintaining effects. In addition, improvement of workability during dough shaping can be expected.

The protein glutaminase used in the present description is not particularly limited as long as it achieves the effect found by the present inventor. For example, the protein-glutaminase may be the one described in WO2010/029685, or a protein-glutaminase preparation PG-50 (manufactured by Amano Enzyme Inc.).

The protein-glutaminase content is, for example, from 2.5% to 50%. In principal, the protein-glutaminase activity is calculated by the method shown in the below-described test example.

In another embodiment of the present invention, glucoamylase, lipase, and protein-glutaminase are used in combination. More specifically, a quality improving agent containing glucoamylase, lipase, and protein-glutaminase is provided. The combined use of these three enzymes can maximize, for example, softness and elasticity maintaining effect. In addition, whitening effect and improvement of workability during dough shaping can be expected.

As shown by the below-described examples, lipase and protein-glutaminase achieved a certain level of quality improvement effect even when used alone. Therefore, in one embodiment of the present invention, lipase and/or protein-glutaminase are used as active ingredients. When lipase is used alone or in combination with protein-glutaminase, it works as a quality improving agent having good color tone improvement effect in both cases. On the other hand, when protein-glutaminase is used alone or in combination with lipase, it works as a quality improving agent which maintains softness and improves workability during dough shaping.

### 2. Method for Producing Steamed Buns

A second aspect of the present invention relates to a method for producing steamed buns using the quality improving agent of the present invention. According to the production method of the present invention, high quality steamed buns are obtained. The production method of the present invention includes a step of steaming a dough containing the above-described quality improving agent. For example, the quality improving agent is added during kneading of ingredients such as flour, and the mixture is blended. Alternatively, the quality improving agent is added after kneading the ingredients such as flour, and the mixture is blended. Yet alternatively, the quality improving agent may be previously mixed with the ingredients such as wheat (the use of premix powder).

When a quality improving agent containing glucoamylase is used (including the combined use with other enzyme), the dose of the enzyme is from 100 U to 2000 U, and preferably from 300 U to 1000 U for 1 kg of the main ingredient. Similarly, when a quality improving agent containing lipase is used (including the combined use with other enzyme), the dose of the enzyme is, for example, from 150 U to 4500 U, and preferably from 750 U to 3000 U for 1 kg of the main ingredient, and when a quality improving agent containing protein glutaminase is used (including the combined use with other enzyme), the dose of the enzyme is, for example, from 0.5 U to 5 U, and preferably from 0.5 U to 2 U for 1 kg of the main ingredient. The main ingredient is the ingredient or material feeding the main component of the steamed bread dough. For example, the main ingredient of Mantou (Chinese steamed bun) and Chinese bun is wheat.

When two or more enzymes are used in combination, additive or synergistic effect is exerted, so that the enzyme dose may be reduced, as long as the sufficient effect according to the intended use is achieved. The reduction of the enzyme dose is preferred from the viewpoint of cost, and also for the reduction of the total amount of additives in the product. The optimum dose can be easily established through a preliminary experiment.

The steaming time and steaming method may follow a common procedure. For example, the product is steamed for about 5 minutes to 1 hour in a steamer filled with vapor. The steaming time may be appropriately adjusted in consideration of the type, characteristics, and size of the product.

The present invention is described below in more detail with reference to test example and examples.

### TEST EXAMPLE

### Activity Measurement Method of Starch-Saccharifying Power (S-Amy, pH 4.5)

1 g of dried soluble starch is suspended to a small amount of water, the suspension is added to about 100 ml of boiling water, boiled for 5 minutes after it starts to boil, and cooled in running water. After cooling, 10 ml of 1 M acetic acid-sodium acetate buffer (pH 4.5) and water are added to make the volume 200 ml. 10 ml of the adjusted substrate is placed in a 100-ml conical flask, and allowed to stand for 10 minutes in a constant temperature bath at 40±0.1° C. 1 ml of the sample solution (diluent is 0.05 M acetic acid-sodium acetate buffer (pH 4.5)) is added to the substrate, thoroughly shaken, and immediately placed and allowed to stand for accurately 30 minutes in a constant temperature bath at 40±0.1° C. After a lapse of 30 minutes, 4 ml of Fehling's test solution is added, and thoroughly shaken. The liquid is placed on a gas burner (on a glass ceramic plate), the fire power is adjusted such that the liquid comes to a boil in 60±30 seconds. After the liquid is boiled for accurately 2 minutes, the liquid is cooled in running water. After cooling, 2 ml of potassium iodide solution (30%) and 2 ml of sulfuric acid solution (25%) are added in this order, and immediately titrated with 0.05 M sodium thiosulfate solution (for assay). The end point of titration is the point when the liquid color changes to white. When the end point is obscure, 2 to 3 drops of starch test solution are added, and titration is continued until the liquid color changes to white. As a blank, water is used in place of the sample solution, and treated in the same manner as above. Under these conditions, the amount of enzyme which brings about the increase of the reducing power equivalent to 10 mg of glucose in 30 minutes is set at 1 unit.

### (Activity Measurement Method of Protease (pH 6.0))

Accurately 1.500 g of milk casein is measured, and 20 mL of dilute sodium hydroxide test solution is added. The mixture is dissolved under heating at 90 to 95° C. accurately for 10 minutes while occasionally stirred, and then cooled. After cooling, 1/30 mol/L phosphoric acid test solution is added to adjust the pH to 6.00, 20 mL of 0.1 mol/L phosphate buffer (pH 6.0) and water are added to make the volume 100 mL. 1 mL of casein solution is measured in a test tube (15×150 mm), allowed to stand at 37±0.5° C. for 10 to 15 minutes, and 1 mL of the sample solution is added and immediately shaken. The liquid is allowed to stand at 37±0.5° C. accurately for 60 minutes, 2 mL of 0.4 mol/L trichloroacetic acid test solution is added, thoroughly shaken, further allowed to stand at 37±0.5° C. for accurately 25 minutes, and then filtered (filter paper, No. 131, 7 cm). Subsequently, 5 mL of 0.4 mol/L sodium carbonate test solution is measured in a test tube (18×180 mm), 1 mL of the above-described filtrate and 1 mL of diluted Folin's reagent (1→5), thoroughly shaken, and allowed to stand at 37±0.5° C. accurately for 20 minutes. The liquid was measured for the absorbance at a wavelength of 660 nm, using water as the control. Aside from this, 2 mL of 0.4 mol/L trichloroacetic acid test solution was added to 1 mL of casein solution, shaken, and 1 mL of water or sample solution was added. The mixture was treated in the same manner as above, and its absorbance was measured. Under these conditions, the amount of enzyme which brings about the generation of amino acid equivalent to 100 μg of tyrosine in 1 mL of the reactant filtrate in 60 minutes is set at 1 unit.

### (Measurement Method of Lipase Activity)

200 g of anhydrous sodium carbonate is dissolved in 400 mL of water, the solution was added while gently stirring to about 1.5 L of olive oil (Japan Pharmacopoeia), which has been warmed at 45±0.5° C. for 20 minutes, in such a manner no emulsification occurs, and the mixture is further stirred at room temperature for about 15 minutes. The object is allowed to stand at room temperature for 20 hours or more, and the oil is collected by centrifugation (5° C., 5,000 min⁻¹, 20 minutes). 51.4 mL of the neutral olive oil thus obtained and 158 mL of gum arabic solution are placed in a homogenizer vessel, and emulsified at 16,000±500 min⁻¹ for 30 minutes. 9 mL of water, 2 mL of sodium taurocholate test solution, and 24 mL of neutral olive oil emulsion were placed and mixed in a flat-bottomed test tube (32×130 mm), and allowed to stand at 37±0.5° C. for 10 to 15 minutes. A pH electrode and a tube for injecting 0.02 mol/L sodium hydroxide solution (for assay) are immersed in the liquid, and the liquid is continuously stirred while nitrogen gas is blown on the liquid surface to prevent the influence of carbon dioxide in air. The pH is adjusted to 7.00 with 0.02 mol/L sodium hydroxide (for assay), the buret is set at “0”. The reaction is started by adding 5 mL of the sample solution. Immediately 0.02 mol/L sodium hydroxide (for assay) is continuously dropped so as to keep the pH at 7.00, and 0.02 mol/L of sodium hydroxide (for assay) is added accurately after 10 minutes to adjust the pH to 9.00 (the pH is adjusted to 9.00 within 30 seconds after completion of dropping for 10 minutes). The amount used of 0.02 mol/L sodium hydroxide (for assay) is recorded (V₁₀). The blank solution is treated in the same manner, except that the sample solution is added after adjusting the pH to 9.00, the pH is adjusted to 9.00 again, and the amount used of 0.02 mol/L sodium hydroxide (for assay) is recorded (V₀). Under these conditions, the unit forming 1 micromole of free fatty acid in 1 minute is set at 1 unit, and the lipase activity is calculated by the following equation.

Lipase activity (U/mg)=(V₁₀−V₀)×diluting multiple×0.0004

### (Activity Measurement Method of Protein-Glutaminase)

The substrate solution is prepared as follows: 0.506 g of benzyloxycarbonyl-L-glutaminylglycine (manufactured by Peptide Institute Inc.: abbreviated name Z-Gln-Gly), is measured, dissolved in 0.2 mol/L phosphoric acid-potassium disodium phosphate buffer (pH 6.5), and the volume is adjusted to 50 mL. The color development test solution A is prepared as follows: 4.05 g of phenol and 0.015 g of sodium pentacyanonitrosylferrate (III) dihydrate are measured, dissolved in about 60 mL of water, and water is further added to make the volume 100 mL (a solution containing 0.43 mol/L phenol and 0.50 mol/L sodium pentacyano nitrile ferrate (III) dihydrate is obtained). The color development test solution B is prepared as follows: 4.99 g of potassium hydroxide is measured, dissolved in about 60 mL of water, and water is further added to make the volume 100 mL (0.89 mol/L potassium hydroxide aqueous solution is obtained). The color development test solution C (potassium carbonate, sodium hypochlorite aqueous solution) is prepared as follows: 20.04 g of anhydrous potassium carbonate and 0.83 mL of sodium hypochlorite are measured, dissolved in about 60 mL of water, and water is further added to make the volume 100 mL. 0.1 mL of the sample solution is placed in a test tube (18×130 mm), allowed to stand in a constant temperature bath at 37±0.5° C. accurately for 1 minute, and then 1 mL of the substrate solution, which has been allowed to stand at 37±0.5° C. for 10 minutes, is accurately added, and immediately mixed. The liquid is allowed to stand for accurately 10 minutes, 1 mL of 0.4 mol/L trichloroacetic acid test solution is added to the liquid, and the mixture is taken out from the constant temperature bath. The reaction liquid is prepared as follows. Firstly, 0.2 mL of the reaction liquid is placed in another test tube (18×130 mm) containing 0.8 mL of water, and they are mixed. Subsequently, 1.0 mL of the color development test solution A is added and mixed, and then 0.5 mL of the color development test solution B is added and mixed. In addition, 1.0 mL of the color development test solution C is added and mixed, and the mixture is placed in a constant temperature bath at 37±0.5° C., and allowed to stand for accurately 20 minutes for color development. After the color development operation, the solution is cooled in running water, and measured for the absorbance at a wavelength of 630 nm using water as control. As a blank, 0.1 mL of the sample solution is placed in a test tube (18×130 mm), 1 mL of 0.4 mol/L trichloroacetic acid test solution is added and mixed, and then 1 mL of the substrate solution is added and mixed. The blank solution is prepared as follows. Firstly, 0.8 mL of water is added in another test tube (18×130 mm) in advance. 0.2 mL of the blank solution is added to the water, and mixed. Subsequently, 1.0 mL of the color development test solution A is added and mixed, 0.5 mL of the color development test solution B is added and mixed, and then 1.0 mL of the color development test solution C is added and mixed. The mixture is placed in a constant temperature bath at 37±0.5° C., and allowed to stand accurately for 20 minutes for color development. After the color development operation, the solution is cooled in running water, and measured for the absorbance at a wavelength of 630 nm using water as control. The absorbance is measured within 60 minutes after the color development operation. Under these conditions, the amount of enzyme forming 1 μmol of ammonia in 1 minute is set at 1 unit.

### (Method for Producing Steamed Bun)

Steamed buns were produced by the straight process according to the recipe shown below (Table 1). The recipe A was used in the examples, unless otherwise noted. The following recipe was prepared, and the dough was mixed on the basis of the program of an automatic bread maker (Home Bakery SD-BT50, manufactured by Panasonic Corporation). After fermentation at 35° C. for 40 minutes, the dough was divided into 100 g pieces. The divided dough pieces were taken by hand, smoothened on the surface, and enclosed into the palm of the hand so as to be shaped into balls. Subsequently, the dough was allowed to stand at room temperature for 20 minutes, with the dough surface covered with a wet cloth to prevent drying. After standing, a wringed cloth was placed on a steamer containing water, the steamer was heated, the dough pieces were arranged at intervals after sufficient steam was up, and steamed for 15 minutes with a lid closed. The steamed dough was taken out, cooled for 2 hours to room temperature, and then stored at 25° C. in a plastic bag.

TABLE 1

| | |
|---|---|
| Recipe A | Recipe B |

| Ingredients | (g) | (%) | (g) | (%) |
|---|---|---|---|---|
| Strong flour | 130 | 50 | 130 | 50 |
| (Nisshin Camelia) | | | | |
| Weak four | 130 | 50 | 130 | 50 |
| (Nisshin Camelia) | | | | |
| Dry yeast | 2.6 | 1 | 2.6 | 1 |
| Sugar | 13 | 5 | 0 | 0 |
| Shortening | 13 | 5 | 0 | 0 |
| Purified water | 120 | 46 | 120 | 46 |

### (Method for Evaluating Steamed Buns)

Four items (specific volume, softness, elasticity, and sensory test) were evaluated. The volume was measured by the rapeseed-substitution method, and the volume (mL) was divided by the steamed bun weight (g) and recorded as the specific volume. The softness and elasticity were evaluated by measuring the indentation load using a rheometer (SUN RHEO METER COMPAC-100II; manufactured by Sun Scientific Co., Ltd.).

Softness and elasticity of the steamed bun were measured as follows. A steamed bun was sliced to a thickness of 20 mm, punched out into a circle shape, and pressed at a pressing rate of 1 mm/s. The load at the point when the thickness of the steamed bun was reduced to half its original thickness was measured, and recorded as the softness (=maximum load (g)). The steamed bun pressed to half thickness was fixed for 30 seconds, the load at that point (30 seconds after) was measured, and the value was divided by the maximum load and recorded as elasticity (%).

Workability during preparation of the dough and sensory test were evaluated by panelists. In the sensory test, a steamed bun immediately after steaming was evaluated. The evaluated six items were uniformity of the internal phase, texture in the mouth, flavor, sweetness, whiteness, and crispness. The evaluation criteria are as follows.

++: Very good in comparison with control

+: Good in comparison with control

±: No change in comparison with control

−: Poor in comparison with control

--: Very poor in comparison with control

### EXAMPLES

### Example 1

### Use of Glucoamylase in Steamed Bun (1)

Various enzymes were added to the ingredients of the recipe A, and steamed buns were produced by the above-described method. The enzymes were SOFTMAX S (glucoamylase preparation with low protease activity; manufactured by Amano Enzyme Inc.) and GLUCZYME AF6 (glucoamylase preparation derived from Rizopus oryzae; manufactured by Amano Enzyme Inc.). In the following examples, the basic recipe, process, and evaluation method were the same as those described in the test example unless otherwise noted. The enzymatic activity for each dose is shown in Table 2.

TABLE 2

| | Starch-saccharifying | | |
|---|---|---|---|
| | power (S-Amy) | Protease (Pro) | |
| | (pH 4.5) u/g | (pH 6.0) u/g | Pro/S-Amy |
| GLUCZYME AF6 | 16400 | 670 | 0.041 |
| SOFTMAX S | 10480 | 60 | 0.006 |

The enzyme preparation was added as follows (Formulae 1 to 5), and the steamed bun was evaluated.

Formula 1: enzyme preparation-free (control)

Formula 2: GLUCZYME AF6 at a dose of 1000 units per kg of flour

Formula 3: SOFTMAX S at a dose of 1000 units per kg of flour

Formula 4: GLUCZYME AF6 at a dose of 2000 units per kg of flour

Formula 5: SOFTMAX S at a dose of 2000 units per kg of flour

The measurement results and evaluation results after storage for 4 hours, 1 day, and 3 days are summarized in Table 3.

TABLE 3

| | Specific | Steamed bun | | | Steamed bun | | | | Sensory test | | | | | |
|---|---|---|---|---|---|---|---|---|---|---|---|---|---|---|
| Test | volume | softness (g) | | | elasticity (%) | | | Work- | White- | Unifor- | Sweet- | | Texture in | Crisp- |
| group | (ml/g) | 4 h | 1 day | 3 days | 4 h | 1 day | 3 days | ability | ness | mity | ness | Flavor | the mouth | ness |
| Formula 1 | 2.47 | 757 | 1683 | 2267 | 56.4 | 50.6 | 44.8 | ± | ± | ± | ± | ± | ± | ± |
| Formula 2 | 2.78 | 670 | 1007 | 1557 | 55.2 | 47.0 | 40.4 | − | ± | ± | + | ± | + | ± |
| Formula 3 | 2.68 | 487 | 1070 | 1680 | 57.1 | 52.0 | 44.6 | ± | ± | ± | + | ± | + | ± |
| Formula 4 | 0.00 | | | | | | | − − | | | | | | |
| Formula 5 | 2.46 | 543 | 1047 | 1403 | 54.0 | 51.2 | 45.7 | ± | ± | ± | + | ± | + | ± |

The addition of GLUCZYME AF6 at a dose of 1000 units per kg of flour showed the effect of maintaining softness of steamed buns. However, the addition of GLUCZYME AF6 at a dose of 2000 units per kg of flour caused stickiness, and the dough did not stand, and could not be shaped into steamed buns. On the other hand, the addition of SOFTMAX S at a dose of 2000 units per kg of flour did not cause stickiness of the dough, so that good workability was achieved. These facts suggest that the high activity of the protease likely influences the workability during preparation of the dough.

### Example 2

### Use of Glucoamylase in Steamed Bun (2)

Using a glucoamylase preparation derived from Rizopus oryzae, GA agents having different levels of protease activity were prepared. The ratio of the starch-saccharifying power and protease activity of the enzyme preparations (GA I, GA II, GA III, and GA IV) are shown in Table 4.

TABLE 4

| | Starch-saccharifying | | |
|---|---|---|---|
| | power (S-Amy) | Protease (Pro) | |
| | (pH 4.5) u/g | (pH 6.0) u/g | Pro/S-Amy |
| GAI | 10874 | 393 | 0.036 |
| GAII | 10235 | 239 | 0.023 |
| GAIII | 10148 | 136 | 0.013 |
| GAIV | 10182 | 33 | 0.003 |

The enzyme was added as follows based on the recipes of Example 1.

Formula 1: Enzyme agent-free (control)

Formula 2: GA I at a dose of 2000 units per kg of flour

Formula 3: GA II at a dose of 2000 units per kg of flour

Formula 4: GA III at a dose of 2000 units per kg of flour

Formula 5: GA IV at a dose of 2000 units per kg of flour

The measurement results and evaluation results after storage for 1 day and 3 days are summarized in Table 5.

TABLE 5

| | Specific | Steamed bun | | Steamed bun | | | Sensory test | | | | | |
|---|---|---|---|---|---|---|---|---|---|---|---|---|
| Test | volume | softness (g) | | elasticity (%) | | Work- | White- | Unifor- | Sweet- | | Texture in | Crisp- |
| group | (ml/g) | 1 day | 3 days | 1 day | 3 days | ability | ness | mity | ness | Flavor | the mouth | ness |
| Formula 1 | 2.41 | 1827 | 2317 | 47.2 | 44.2 | ± | ± | ± | ± | ± | ± | ± |
| Formula 2 | | | | | | − − | | | | | | |
| Formula 3 | | | | | | − − | | | | | | |
| Formula 4 | 2.44 | 1143 | 1403 | 48.3 | 46.6 | − | ± | ± | + | ± | + | ± |
| Formula 5 | 2.57 | 1290 | 1337 | 50.4 | 49.6 | ± | ± | ± | + | ± | + | ± |

The use of Pro/S-Amy ratio 0.036 and 0.023 in the glucoamylase preparation caused stickiness when added at a dose of 2000 units per kg of flour, and the dough did not stand and could not be shaped into steamed buns. The addition of Pro/S-Amy ratio 0.013 at a dose of 2000 units per kg of flour achieved the effect of maintaining softness of steamed buns, but the steamed buns had rather poor elasticity. Therefore, the Pro/S-Amy ratio is likely preferably a contaminant protease ratio of 0.01 or less.

### Example 3

### Use of Glucoamylase in Steamed Bun (3)

The enzyme was added as follows based on the recipes of Example 1.

Formula 1: Enzyme agent-free (control)

Formula 2: NOVAMYL 10000BG at a concentration of 50 ppm

Formula 3: NOVAMYL (registered trademark) Steam at a concentration of 50 ppm

Formula 4: SOFTMAX S at a dose of 250 units per kg of flour

Formula 5: SOFTMAX S at a dose of 500 units per kg of flour

Formula 6: SOFTMAX S at a dose of 1000 units per kg of flour

The measurement results and evaluation results after storage for 3 days are summarized in Table 6.

TABLE 6

| | Specific | Steamed bun | Steamed bun | | Sensory test | | | | | |
|---|---|---|---|---|---|---|---|---|---|---|
| Test | volume | softness (g) | elasticity (%) | Work- | White- | Unifor- | Sweet- | | Texture in | Crisp- |
| group | (ml/g) | 3 days | 3 days | ability | ness | mity | ness | Flavor | the mouth | ness |
| Formula 1 | 2.20 | 3100 | 45.1% | ± | ± | ± | ± | ± | ± | ± |
| Formula 2 | 2.17 | 2120 | 44.2% | ± | ± | ± | + | ± | ± | − − |
| Formula 3 | 2.07 | 2590 | 45.2% | ± | ± | ± | + | ± | ± | − |
| Formula 4 | 2.33 | 2690 | 45.9% | ± | ± | ± | + | ± | ± | ± |
| Formula 5 | 2.40 | 2130 | 45.2% | ± | ± | ± | + | ± | + | ± |
| Formula 6 | 2.47 | 1810 | 45.6% | ± | ± | ± | + | ± | + | ± |

The above results indicate that the addition of SOFTMAX S at a dose of 250 units or more per kg of flour increases the specific volume, and improves steamed buns in the texture in the mouth and crispness.

### Example 4

### Use of Glucoamylase in Steamed Bun (4)

On the basis of the recipes in Example 1, the enzyme was added as follows. The enzyme preparation used herein were BIOZYME F10SD (α-amylase derived from Aspergillus oryzae, manufactured by Amano Enzyme Inc.) and Hemicellulase “AMANO” 90 (hemicellulase preparation derived from Aspergillus niger, manufactured by Amano Enzyme Inc.), and the glucose oxidase was HYDERASE 15 (glucose oxidase preparation derived from Aspergillus niger, manufactured by Amano Enzyme Inc.). The measurement results and evaluation results after storage for 4 hour and 3 days are summarized in Table 7.

Formula 1: enzyme preparation—free (control)

Formula 2: BIOZYME F10SD at a concentration of 5 ppm

Formula 3: Hemicellulase “AMANO” 90 at a concentration of 50 ppm

Formula 4: HYDERASE 15 at a concentration of 30 ppm

Formula 5: SOFTMAX S at a dose of 2000 units per kg of flour

TABLE 7

| | Specific | Steamed bun | | Steamed bun | | | Sensory test | | | | | |
|---|---|---|---|---|---|---|---|---|---|---|---|---|
| Test | volume | softness (g) | | elasticity (%) | | Work- | White- | Unifor- | Sweet- | | Texture in | Crisp- |
| group | (ml/g) | 4 h | 3 days | 4 h | 3 days | ability | ness | mity | ness | Flavor | the mouth | ness |
| Formula 1 | 2.18 | 1250 | 3270 | 54.2 | 42.0 | ± | ± | ± | ± | ± | ± | ± |
| Formula 2 | 2.31 | 767 | 2343 | 54.5 | 46.1 | ± | ± | ± | ± | ± | + | ± |
| Formula 3 | 2.62 | 717 | 2160 | 57.3 | 44.9 | − | ± | ± | ± | ± | + | ± |
| Formula 4 | 2.20 | 967 | 2817 | 54.5 | 46.0 | + | ± | ± | ± | ± | ± | ± |
| Formula 5 | 2.54 | 363 | 1834 | 58.7 | 48.3 | ± | ± | ± | + | ± | + | ± |

The results indicate that BIOZYME F10SD has aging prevention effect. Hemicellulase “AMANO” 90 markedly increased the steamed bun volume, but presented problem with the dough workability. HYDERASE 15 caused moderate drying of the steamed bun surface, but had an advantage in dough workability. SOFTMAX S produced steamed buns having high volumes, lasting softness, high sweetness, and good texture in the mouth.

### Example 5

### Use of Lipase in Steamed Bun

On the basis of the recipes in Example 1, the enzyme was added as follows. The enzyme agents used herein were Lipase DF “AMANO” 15 (lipase preparation derived from Rhizopus delemar, manufactured by Amano Enzyme Inc.), Lipase M “AMANO” (lipase preparation derived from Mucor javanicus, manufactured by Amano Enzyme Inc.), LIPOPAN™ 50BG (an enzyme preparation obtained by recombining the gene derived from Thermomyces lanuginosus by Aspergillus oryzae, manufactured by Novozymes), and LIPOPAN FBG (an enzyme preparation obtained by recombining the gene derived from Fusarium oxysporum by Aspergillus oryzae, manufactured by Novozymes).

Formula 1: enzyme agent-free (control)

Formula 2: LIPOPAN™ 50BG at a concentration of 50 ppm

Formula 3: LIPOPAN FBG at a concentration of 60 ppm

Formula 4: Lipase M “AMANO” at a concentration of 10 ppm

Formula 5: Lipase DF “AMANO” 15 at a dose of 1500 units per kg of flour

The measurement results and evaluation results after storage for 1 day and 4 days are summarized in Table 8.

TABLE 8

| | Specific | Steamed bun | | Steamed bun | | | Sensory test | | | | | |
|---|---|---|---|---|---|---|---|---|---|---|---|---|
| Test | volume | softness (g) | | elasticity (%) | | Work- | White- | Unifor- | Sweet- | | Texture in | Crisp- |
| group | (ml/g) | 1 day | 4 days | 1 day | 4 days | ability | ness | mity | ness | Flavor | the mouth | ness |
| Formula 1 | 2.15 | 2500 | 3337 | 49.1 | 44.6 | ± | ± | ± | ± | ± | ± | ± |
| Formula 2 | 2.23 | 1960 | 2650 | 47.8 | 45.0 | + | + | + | ± | ± | ± | ± |
| Formula 3 | 2.33 | 1900 | 2913 | 50.4 | 47.7 | + | + | + | ± | ± | + | ± |
| Formula 4 | 2.42 | 1650 | 2533 | 51.5 | 48.3 | + | + + | + | ± | ± | + | ± |
| Formula 5 | 2.32 | 1797 | 2007 | 48.4 | 47.2 | + | + + | + | ± | ± | + | ± |

All of the lipase agents, or LIPOPAN™ 50BG, LIPOPAN FBG, Lipase M “AMANO”, and Lipase DF “AMANO” 15 showed whitening effect on steamed buns. In particular, Lipase DF “AMANO” 15 showed marked anti-staling effect.

### Example 6

### Effect of Combined Use of Lipase and Glucoamylase on Steamed Bun

In order to validate the effect of combined use of lipase and glucoamylase, the addition of the two enzyme preparations, SOFTMAX S and Lipase DF “AMANO” 15 was tested and compared.

Formula 1: enzyme agent-free (control)

Formula 2: NOVAMYL 10000BG at a concentration of 50 ppm

Formula 3: NOVAMYL (registered trademark) Steam at a concentration of 50 ppm

Formula 4: SOFTMAX S at a dose of 1000 units per kg of flour

Formula 5: Lipase DF “AMANO” 15 at a dose of 1500 units per kg of flour

Formula 6: SOFTMAX S at a dose of 1000 units per kg flour and Lipase DF “AMANO” 15 at a dose of 1500 units per kg of flour

The measurement results and evaluation results after storage for 4 hours, 1 day, and 3 days are summarized in Table 9.

TABLE 9

| | Specific | Steamed bun | | | Steamed bun | | | | Sensory test | | | | | |
|---|---|---|---|---|---|---|---|---|---|---|---|---|---|---|
| Test | volume | softness (g) | | | elasticity (%) | | | Work- | White- | Unifor- | Sweet- | | Texture in | Crisp- |
| group | (ml/g) | 4 h | 1 day | 3 days | 4 h | 1 day | 3 days | ability | ness | mity | ness | Flavor | the mouth | ness |
| Formula 1 | 2.16 | 1160 | 1660 | 3190 | 54.9 | 50.2 | 46.3 | ± | ± | ± | ± | ± | ± | ± |
| Formula 2 | 2.14 | 1277 | 1613 | 2790 | 54.4 | 53.1 | 46.6 | ± | ± | ± | + | ± | ± | − − |
| Formula 3 | 2.15 | 1353 | 1603 | 2583 | 55.0 | 52.5 | 44.6 | ± | ± | ± | + | ± | ± | − |
| Formula 4 | 2.41 | 933 | 1603 | 2320 | 56.3 | 53.2 | 46.9 | ± | ± | ± | + | ± | + | ± |
| Formula 5 | 2.32 | 1083 | 1503 | 2710 | 51.7 | 50.3 | 46.6 | + | + + | + | ± | ± | + | ± |
| Formula 6 | 2.46 | 927 | 1097 | 1807 | 52.2 | 51.7 | 47.2 | ± | + + | + | + | ± | + | ± |

The combined use of SOFTMAX S and Lipase DF “AMANO” 15 achieved higher softness maintaining effect than the single use of them.

Further, the synergistic effect of the combined use of SOFTMAX S and Lipase DF “AMANO” 15 at low doses was evaluated. In addition, the recipe B was also evaluated

Formula 1: enzyme preparation-free (control)

Formula 2: NOVAMYL (registered trademark) Steam at a dose of 300 units per kg of flour, and Lipase DF “AMANO” 15 at a dose of 1500 units per kg of flour (recipe A)

Formula 3: SOFTMAX S at a dose of 30 ppm, Lipase DF “AMANO” 15 at a dose of 10 ppm (recipe A)

Formula 4: enzyme preparation-free (control) (recipe B)

Formula 5: NOVAMYL (registered trademark) Steam at a dose of 50 ppm (recipe B)

Formula 6: SOFTMAX S at a dose of 300 units per kg of flour, and Lipase DF “AMANO” 15 at a dose of 1500 units per kg of flour (recipe B)

The measurement results and evaluation results after storage for 4 hours, 1 day, and 2 days are summarized in Table 10.

TABLE 10

| | Specific | Steamed bun | | | Steamed bun | | | | Sensory test | | | | | |
|---|---|---|---|---|---|---|---|---|---|---|---|---|---|---|
| Test | volume | softness (g) | | | elasticity (%) | | | Work- | White- | Unifor- | Sweet- | | Texture in | Crisp- |
| group | (ml/g) | 4 h | 1 day | 2 days | 4 h | 1 day | 2 days | ability | ness | mity | ness | Flavor | the mouth | ness |
| Formula 1 | 2.20 | 897 | 1820 | 2633 | 54.1 | 52.2 | 42.3 | ± | ± | ± | ± | ± | ± | ± |
| Formula 2 | 2.29 | 890 | 1443 | 1693 | 53.5 | 48.2 | 42.9 | ± | ± | ± | + | ± | ± | − |
| Formula 3 | 2.58 | 707 | 1143 | 1547 | 49.0 | 47.3 | 46.4 | + | + + | + | + | ± | + | ± |
| Formula 4 | 1.86 | 1700 | 3053 | 4180 | 57.5 | 49.1 | 45.0 | ± | ± | ± | ± | ± | ± | ± |
| Formula 5 | 1.85 | 1883 | 2493 | 3835 | 53.5 | 50.5 | 46.2 | ± | ± | ± | + | ± | ± | ± |
| Formula 6 | 2.28 | 1390 | 1837 | 2870 | 53.7 | 53.5 | 49.3 | + + | + + | + | + | ± | + + | ± |

The above results indicate that the addition of SOFTMAX S at a dose of 300 units per kg of flour and Lipase DF “AMANO” 15 at a dose of 1500 units per kg of flour achieves the anti-staling and whitening effect whether the recipe A or recipe B, which uses no shortening or sugar, is used.

### Example 7

### Use of Protein-Glutaminase in Steamed Bun

The enzyme preparation used herein was protein-glutaminase (PG-50, an enzyme preparation derived from Chryseobacterium proteolyticum; manufactured by Amano Enzyme Inc.).

Formula 1: enzyme preparation-free (control)

Formula 2: PG-50 at a dose of 0.25 units per kg of flour

Formula 3: PG-50 at a dose of 1 unit per kg of flour

Formula 4: PG-50 at a dose of 2 units per kg of flour

The measurement results and evaluation results after storage for 1 day and 4 days are summarized in Table 11.

TABLE 11

| | Specific | Steamed bun | | Steamed bun | | | Sensory test | | | | | |
|---|---|---|---|---|---|---|---|---|---|---|---|---|
| Test | volume | softness (g) | | elasticity (%) | | Work- | White- | Unifor- | Sweet- | | Texture in | Crisp- |
| group | (ml/g) | 1 day | 4 days | 1 day | 4 days | ability | ness | mity | ness | Flavor | the mouth | ness |
| Formula 1 | 2.08 | 1870 | 3147 | 49.1 | 43.7 | ± | ± | ± | ± | ± | ± | ± |
| Formula 2 | 2.10 | 1803 | 3157 | 50.2 | 46.1 | ± | ± | ± | ± | ± | ± | ± |
| Formula 3 | 2.17 | 1627 | 3090 | 51.8 | 46.3 | + | ± | ± | ± | ± | ± | ± |
| Formula 4 | 2.11 | 1660 | 2833 | 49.5 | 47.3 | + | ± | ± | ± | ± | ± | ± |

The above results indicate that the addition of PG-50 at a dose of 1 unit or more per kg of flour achieved the softness maintaining effect on steamed buns, and improved workability during dough shaping.

### Example 8

### Effect of Combined Use of Glucoamylase and Protein-Glutaminase on Steamed Bun

Further, the effect of combined use of glucoamylase and protein-glutaminase was validated. The glucoamylase used herein was SOFTMAX S, and the protein-glutaminase was PG-50. The enzyme preparations were added as follows, and a comparative experiment was carried out.

Formula 1: enzyme preparation-free (control)

Formula 2: SOFTMAX S at a dose of 1000 units per kg of flour

Formula 3: PG-50 at a dose of 1 unit per kg of flour

Formula 4: SOFTMAX S at a dose of 1000 units per kg of flour, PG-50 at a dose of 1 unit per kg of flour

The measurement results and evaluation results after storage for 1 day and 4 days are summarized in Table 12.

TABLE 12

| | Specific | Steamed bun | | Steamed bun | | | Sensory test | | | | | |
|---|---|---|---|---|---|---|---|---|---|---|---|---|
| Test | volume | softness (g) | | elasticity (%) | | Work- | White- | Unifor- | Sweet- | | Texture in | Crisp- |
| group | (ml/g) | 1 day | 4 days | 1 day | 4 days | ability | ness | mity | ness | Flavor | the mouth | ness |
| Formula 1 | 2.33 | 1847 | 2520 | 48.1 | 45.1 | ± | ± | ± | ± | ± | ± | ± |
| Formula 2 | 2.60 | 1033 | 1527 | 49.9 | 47.7 | ± | ± | ± | + | ± | + | ± |
| Formula 3 | 2.36 | 1777 | 2467 | 45.5 | 43.5 | + | ± | ± | ± | ± | ± | ± |
| Formula 4 | 2.64 | 1013 | 1390 | 48.4 | 49.5 | + | ± | ± | + | ± | + | ± |

The above results indicate that the combined use of SOFTMAX S and PG-50 is more effective in the maintenance of softness and elasticity in steamed buns than the single use of them.

Further, the effect of the glucoamylase at a reduced dose was also studied.

The enzyme preparation was added as follows, and a comparative experiment was carried out.

Formula 1: enzyme preparation-free (control)

Formula 2: SOFTMAX S at a dose of 300 units per kg of flour

Formula 3: PG-50 at a dose of 1 unit per kg of flour

Formula 4: SOFTMAX S at a dose of 300 units per kg of flour, and PG-50 at a dose of 1 unit per kg of flour

The measurement results and evaluation results after storage for 4 hours, 1 day, and 2 days are summarized in Table 13.

TABLE 13

| | Specific | Steamed bun | | | Steamed bun | | | | Sensory test | | | | | |
|---|---|---|---|---|---|---|---|---|---|---|---|---|---|---|
| Test | volume | softness (g) | | | elasticity (%) | | | Work- | White- | Unifor- | Sweet- | | Texture in | Crisp- |
| group | (ml/g) | 4 h | 1 day | 2 days | 4 h | 1 day | 2 days | ability | ness | mity | ness | Flavor | the mouth | ness |
| Formula 1 | 2.30 | 940 | 2093 | 2707 | 54.2 | 49.2 | 47.1 | ± | ± | ± | ± | ± | ± | ± |
| Formula 2 | 2.47 | 657 | 1543 | 2443 | 56.3 | 50.5 | 45.6 | ± | ± | ± | + | ± | + | ± |
| Formula 3 | 2.30 | 740 | 1883 | 2620 | 56.8 | 48.3 | 45.4 | + | ± | ± | ± | ± | ± | ± |
| Formula 4 | 2.52 | 557 | 1517 | 2033 | 58.2 | 51.1 | 45.7 | + | ± | ± | + | ± | + | ± |

The above results indicate that the addition of SOFTMAX S even at a reduced dose achieved sufficient effect.

### Example 9

### Effect of Combined Use of Glucoamylase, Protein-Glutaminase, and Lipase (1)

The enzyme preparations were added as follows, and the steamed bun was evaluated.

Formula 1: enzyme preparation—free (control)

Formula 2: NOVAMYL (registered trademark) Steam at a dose of 50 ppm.

Formula 3: SOFTMAX S at a dose of 100 units per kg of flour, PG-50 at a dose of 1 unit per kg of flour, and Lipase DF15 at a dose of 1500 units per kg of flour

Formula 4: SOFTMAX S at a dose of 200 units per kg of flour, PG-50 at a dose of 1 unit per kg of flour, and Lipase DF15 at a dose of 1500 units per kg of flour

Formula 5: SOFTMAX S at a dose of 300 units per kg of flour, PG-50 at a dose of 1 unit per kg of flour, and Lipase DF15 at a dose of 1500 units per kg of flour

Formula 6: SOFTMAX S at a dose of 500 units per kg of flour, PG-50 at a dose of 1 unit per kg of flour, and Lipase DF15 at a dose of 1500 units per kg of flour

Formula 7: SOFTMAX S at a dose of 1000 units per kg pf flour, PG-50 at a dose of 1 unit per kg of flour, and Lipase DF15 at a dose of 1500 units per kg of flour

The measurement results and evaluation results after storage for 4 hours and 3 days are summarized in Table 14.

TABLE 14

| | Specific | Steamed bun | | Steamed bun | | | Sensory test | | | | | |
|---|---|---|---|---|---|---|---|---|---|---|---|---|
| Test | volume | softness (g) | | elasticity (%) | | Work- | White- | Unifor- | Sweet- | | Texture in | Crisp- |
| group | (ml/g) | 4 h | 3 days | 4 h | 3 days | ability | ness | mity | ness | Flavor | the mouth | ness |
| Formula 1 | 2.13 | 1087 | 2507 | 51.7 | 45.7 | ± | ± | ± | ± | ± | ± | ± |
| Formula 2 | 2.00 | 950 | 2037 | 52.9 | 47.6 | ± | ± | ± | + | ± | ± | − |
| Formula 3 | 2.53 | 643 | 1260 | 53.0 | 46.9 | + | + + | + | + | ± | + | ± |
| Formula 4 | 2.60 | 703 | 1517 | 52.6 | 47.2 | + | + + | + | + | ± | + | ± |
| Formula 5 | 2.59 | 693 | 1230 | 52.9 | 48.8 | + | + + | + | + | ± | + | ± |
| Formula 6 | 2.88 | 583 | 1103 | 53.4 | 48.8 | + | + + | + | + | ± | + | ± |
| Formula 7 | 2.62 | 483 | 917 | 50.7 | 50.1 | + | + + | + | + | ± | + | ± |

The above results indicate that the workability during preparation of the dough of steamed bun was improved as the increase of the amount of glucoamylase in the combined use of the enzyme preparations. In addition, the steamed bun immediately after steaming was very soft (voluminous), did not stick to teeth, maintained good elasticity, and had moderate sweetness.

### Example 10

### Effect of Combined Use of Glucoamylase, Protein-Glutaminase, and Lipase (2)

The steamed bun of the formula of Example 9 was further stored at a low temperature, and evaluated. The steamed bun immediately after steaming was cooled for 2 hours at room temperature (25° C.), and stored at 4° C. for 5 days in a plastic bag. The stored steamed bun was placed back at room temperature (25° C.), heated in a microwave oven (ER-HD500, manufactured by Toshiba Corporation) (“Soft” course was selected. The sample heated in a bag and that heated after taking out from the bag were compared), and then cooled to room temperature (25° C.), and the performance was evaluated. The results are shown in Table 15.

TABLE 15

| | | Steamed bun | | Steamed bun | | | | | | | | |
|---|---|---|---|---|---|---|---|---|---|---|---|---|
| | Specific | softness (g) | | elasticity (%) | | | Sensory test | | | | | |
| Test | volume | 5 days | | 5 days | | Work- | White- | Unifor- | Sweet- | | Texture in | Crisp- |
| group | (ml/g) | With bag | Without bag | With bag | Without bag | ability | ness | mity | ness | Flavor | the mouth | ness |
| Formula 1 | 2.15 | 1660 | 1543 | 44.8 | 47.1 | ± | ± | ± | ± | ± | ± | ± |
| Formula 2 | 2.12 | 2077 | 1450 | 45.0 | 48.8 | ± | ± | ± | + | ± | ± | − |
| Formula 3 | 2.38 | 1870 | 1657 | 42.3 | 43.6 | + | + + | ± | + | ± | ± | ± |
| Formula 4 | 2.53 | 1167 | 1190 | 44.4 | 45.8 | + | + + | + | + | ± | ± | ± |
| Formula 5 | 2.51 | 950 | 1027 | 44.8 | 45.9 | + | + + | + | + | ± | + | ± |
| Formula 6 | 2.60 | 1197 | 977 | 43.0 | 46.1 | + | + + | + | + | ± | + | ± |
| Formula 7 | 2.59 | 867 | 830 | 45.0 | 45.2 | + | + + | + | + | ± | + | ± |

It has been worried that the moisture in steamed buns can escape in the form of vapor when heated in a microwave oven without covering with a bag. The above-described results indicate that the addition of the enzyme preparations improved the functions of steamed buns, whether a bag was used or not during heating in a microwave oven.

### INDUSTRIAL APPLICABILITY

The quality improving agent of the present invention is effective for improving the quality of steamed buns. The quality improving agent of the present invention can maintain the quality of steamed buns (for example, softness and elasticity) for a long period of time, without impairing the taste and flavor of steamed buns. The quality improving agent of the present invention is also useful for improving the quality of steamed buns provided in the form of a frozen or chilled food (usually reheated before eating), and can prevent shrinkage or wrinkling, or swelling of the surface during heating in a microwave oven or the like.

The present invention will not be limited to the above-described embodiments and examples of the present invention. The present invention includes various modifications which can be readily made by those skilled in the art without departing from the claims. The entire contents of literatures, unexamined patent publications, and patent publications specified herein are incorporated herein by reference.

1. A steamed bun quality improving agent comprising glucoamylase.

2. The quality improving agent according to claim 1, which has low protease activity.

3. The quality improving agent according to claim 2, wherein the ratio of protease activity to the starch-saccharifying power (protease activity/starch-saccharifying power) is 0.01 or less.

4. The quality improving agent according to claim 1, which further comprises lipase.

5. The quality improving agent according to claim 1, which further comprises protein-glutaminase.

6. A steamed bun quality improving agent comprising lipase.

7. A steamed bun quality improving agent comprising protein-glutaminase.

8. A method for producing steamed buns, comprising a step of steaming a dough containing the quality improving agent according to claim 1.
